(19) United States
(12) Patent Application Publication
(10) Pub. No.: US 2026/0246189 A1
(43) Pub. Date: Aug. 20, 2026

(54) HIGH-POWER CONNECTOR

(71) Applicant: BIZLINK INTERNATIONAL CORP., New Taipei City (TW)

(72) Inventors: Qixing XU, New Taipei City (TW); Yanping ZHANG, New Taipei City (TW); Haoran ZOU, New Taipei City (TW)

(21) Appl. No.: 19/539,047

(22) Filed: Feb. 13, 2026

(30) Foreign Application Priority Data
Feb. 14, 2025 (CN) 202510169361.7

(51) Int. Cl. H01R 13/506; H01R 13/502; H01R 13/631; H01R 24/60

(52) U.S. Cl. CPC H01R 13/506; H01R 13/502; H01R 13/631; H01R 24/60

(57) ABSTRACT

The present application disclosure pertains to a high-power connector within the field of connector technology. The high-power connector includes a base formed integrally from insulating material, a plurality of terminal modules, and two internally thread metal tubes. The base includes a main body portion and a socket portion. The main body portion includes a through-hole and a rear channel. The socket portion includes at least five front channels arranged side by side. The front channel wall includes guide slopes, a positioning groove, and relief grooves to optimize terminal alignment and minimize insertion interference. The terminal module includes a metal terminal, an insulating cap, and a C-shaped retaining ring. The internally threaded metal tube provides a fixed function, enhancing structural stability and electrical reliability, suitable for high-current applications.

This application claims priority to China Application Serial Number 202510169361.7, filed February 14, 2025, which is herein incorporated by reference in its entirety.

### BACKGROUND

### Field of Invention

The disclosure relates to the field of connector technology, particularly to a high-power connector.

### Description of Related Art

In power management for servers and high-power electronic equipment, connector design is critical for ensuring stable power delivery. However, conventional high-power connectors commonly often suffer from structural weaknesses, unstable terminal fixation, and poor contact quality. These problems can lead to localized overheating, increased power losses, and potential operational disruptions in high-current environments.

To address the these issues, current technologies have attempted to enhance performance by improving terminal structures and increasing the fastening strength of connectors. However, these improvements often fail to balance structural strength with stable terminal positioning, causing assembly complexity and increased costs. Furthermore, existing connectors are prone to mating interference during the connection with receptacle connectors due to manufacturing tolerances, which negatively impacts insertion/removal efficiency and the service life of the terminals.

Consequently, there is an urgent need for an improved connector design that enhances terminal retention stability, reduces mating interference, and increases structural strength while maintaining the connector's dimensions, to meet the demands of high-current equipment such as servers.

### SUMMARY

The primary objective of this present disclosure is to propose a high-power connector designed to enhance terminal retention stability, reduce mating interference, and strengthen structural integrity without increasing connector dimensions. This aims to meet the operational requirements of high-current equipment such as servers.

At least one embodiment of the present disclosure provides a high-power connector for supplying power to a server. The high-power connector includes a base and a plurality of terminal modules. The base is integrally formed from insulating material including a main body portion and a socket portion. The main body portion includes a rear channel and a through hole extending in a front-to-back direction through the main body portion. The maximum height of the main body portion in a height direction is between 12 mm and 26 mm. The socket portion is connected to a front of the main body portion. The socket portion includes at least five front channels and two reverse hooks. At least five front channels are arranged side by side, each of the front channels communicating with a corresponding one of the rear channels and extending from a rear toward a front thereof. The reverse hooks are respectively disposed on opposite sides of the socket portion. Each of the front channels includes a positioning channel wall located on an upper side of the front channel, the positioning channel wall having a positioning groove extending in the front-to-back direction. A maximum height of the socket portion in the height direction is between 11 mm and 25 mm. The maximum height of the socket portion is less than the maximum height of the main body portion, and a maximum depth of the positioning groove in the height direction is between 0.5 mm and 1.5 mm. The terminal modules are respectively disposed in the front channels and the rear channels. Each terminal module includes a metal terminal and an insulating cap. The metal terminal has a foot portion. The insulating cap fixedly mounted on the top of the metal terminal. The foot portion is cylindrical in shape and has a diameter between 2 mm and 10 mm.

At least one embodiment of the present disclosure, the aforementioned socket portion further includes a transverse groove. The transverse groove is defined in a front end surface of the socket portion between two adjacent front channels. The transverse groove extends in a width direction to communicate the two adjacent front channels.

At least one embodiment of the present disclosure, the aforementioned each terminal module further includes a C-shaped retaining ring. The C-shaped retaining ring is engaged with a surface of the metal terminal. The C-shaped retaining ring is configured to abut against the base to prevent the metal terminal corresponding thereto from retreating backward from the base.

At least one embodiment of the present disclosure, the aforementioned high-power connector further includes two internally threaded metal tubes. The two internally threaded metal tubes are respectively embedded in the through holes defined at two lateral sides of the main body portion, in which the two internally threaded metal tubes to provide an internal thread within the through holes.

At least one embodiment of the present disclosure, an edge of the aforementioned front end surface of the socket portion at an opening of each of the at least five front channels is provided with a guide slopes, and the guide slope thickness is between 0.05 mm and 0.5 mm.

At least one embodiment of the present disclosure, the aforementioned insulating cap of each of the terminal modules has at least one opening defined therein to expose a part of a top surface of the metal terminal.

At least one embodiment of the present disclosure, a rear end of the aforementioned C-shaped retaining ring is thicker than a front end of the C-shaped retaining ring.

At least one embodiment of the present disclosure, an interior of at least one of the at least five front channels includes a plurality of front channel walls. The front channel walls includes a plurality of relief channel walls. The relief channel wall includes two lateral relief channel walls and a bottom relief channel wall. The two lateral relief channel walls face each other. The bottom relief channel wall has a relief groove extending along the front-to-back direction.

At least one embodiment of the present disclosure, the aforementioned front channel walls further includes a plurality of planar walls and a positioning channel wall. The positioning channel wall is interconnected between the two lateral relief channel walls via two of the planar walls respectively located at an upper portion of the interior. A relief depth of the relief groove along the height direction is between 0.05 mm and 0.5 mm, and the relief depth is no more than 15% of a maximum thickness of the relief channel wall.

At least one embodiment of the present disclosure, the bottom of each of the aforementioned relief groove is a curved surface.

At least one embodiment of the present disclosure, the aforementioned socket portion further includes a plurality of horizontal support walls, an upper coplanar surface and a lower coplanar surface. The horizontal support walls is interconnected the front channel walls. The upper coplanar surface faces upward. The lower coplanar surface faces downward. The upper coplanar surface is jointly formed by top surfaces of the front channel walls and top surfaces of the horizontal support walls that are flush with each other along the width direction. The lower coplanar surface is jointly formed by bottom surfaces of the front channel walls and bottom surface of the horizontal support walls that are flush with each other along the width direction.

At least one embodiment of the present disclosure, the aforementioned front end opening of each of the front channels has a polygon shape. A periphery of the polygonal shape is collectively defined by a plurality of substantially straight edges.

At least one embodiment of the present disclosure provides a high-power connector for supplying power to a server. The high-power connector includes a base and a plurality of terminal modules. The base is integrally formed from insulating material including a main body portion and a socket portion. The main body portion includes a rear channel and a through hole extending in a front-to-back direction through the main body portion. The socket portion is connected to a front of the main body portion. The socket portion includes at least five front channels and two reverse hooks. At least five front channels are arranged side by side, each of the front channels communicating with a corresponding one of the rear channels and extending from a rear toward a front thereof. The reverse hooks are respectively disposed on opposite sides of the socket portion. Each of the front channels includes a positioning channel wall located on an upper side of the front channel, and the positioning channel wall having a positioning groove extending in the front-to-back direction. A maximum height of the socket portion in the height direction is less than the maximum height of the main body portion. A front end opening of each of the front channels has a polygon. A periphery of the polygonal shape is collectively defined by a plurality of substantially straight edges. The socket portion further includes a transverse groove. The transverse groove is defined in a front end surface of the socket portion between two adjacent front channels. A plurality of terminal modules is respectively disposed in the front channels and the rear channels. Each of terminal modules includes a metal terminal and an insulating cap. The metal terminal includes a foot portion. The insulating cap fixedly mounted on the top of the metal terminal. The foot portion is cylindrical in shape.

At least one embodiment of the present disclosure, the aforementioned each terminal module further includes a C-shaped retaining ring. The C-shaped retaining ring is engaged with a surface of the metal terminal. The C-shaped retaining ring is configured to abut against the base to prevent the metal terminal corresponding thereto from retreating backward from the base.

At least one embodiment of the present disclosure, the aforementioned high-power connector further includes two internally threaded metal tubes. The two internally threaded metal tubes are respectively embedded in the through holes defined at two lateral sides of the main body portion, in which the two internally threaded metal tubes to provide an internal thread within the through hole.

At least one embodiment of the present disclosure, the aforementioned rear channel features a stepped structure that widens toward the front and narrows toward the rear. The stepped structure has a step platform in the middle. The step platform is used to support the C-shaped retaining ring on the metal terminal in an outwardly expanding state, and to prevent the metal terminal from retracting from the base and the front channel thereof.

At least one embodiment of the present disclosure, the aforementioned maximum height of the socket portion is between 11mm and 25mm.

At least one embodiment of the present disclosure, a maximum depth of the transverse groove along a length direction is referred as a transverse groove depth. The transverse groove depth is between 0.3 mm and 1 mm.

At least one embodiment of the present disclosure, the aforementioned maximum height of the main body portion ranges from 12 mm to 26 mm and is slightly greater than the maximum height of the socket portion.

At least one embodiment of the present disclosure, the diameter of the aforementioned insulating cap is between 3 mm and 10 mm.

Based on the aforementioned. In the aforementioned embodiments of the present disclosure of the high-power connector provides an improved connector design that enhances terminal retention stability, reduces mating interference, and strengthens structural integrity without increasing connector dimensions. This design addresses the operational requirements of high-current equipment such as servers.

### BRIEF DESCRIPTION OF THE DRAWINGS

To make the above and other features, advantages, and embodiments of the present disclosure more clearly understood, it should be noted that multiple features are not drawn to an industrially practical scale. In fact, for the sake of clarity in discussion, the dimensions and quantities of various features may be arbitrarily increased or decreased. The components depicted in the present drawings are primarily for illustrative purposes and are not intended to precisely depict the actual shape of the components, nor are they intended to limit the scope of the claims in this disclosure. The detailed description of the attached diagram is as follows:

FIG. 1 is a schematic diagram of the overall structure of a high-power connector according to at least one embodiment of the present disclosure.

FIG. 2 is a schematic diagram of the high-power connector in FIG. 1 from another perspective.

FIG. 3 is a front-view schematic diagram of the high-power connector shown in FIG. 1.

FIG. 4 is a schematic diagram of the terminal modules for the high-power connector shown in FIG. 1.

FIG. 5 is a schematic diagram of the component structure of the terminal module shown in FIG. 4.

FIG. 6 is schematic a cross-section drawn of the high-power connector along section A-A’ in FIG. 2.

FIG. 7 is an enlarged schematic diagram of the front view perspective shown in FIG. 1.

FIG. 8 is an enlarged schematic diagram of the front-lower view perspective shown in FIG. 7.

### DETAILED DESCRIPTION

The following description will clearly and completely explain the technical solutions in the embodiments of the present disclosure with reference to the accompanying drawings. It should be understood that the embodiments described herein represent only a portion of the embodiments of the present disclosure, not all of them. All other embodiments obtained by those skilled in the art based on the embodiments of the present disclosure without performing creative labor fall within the scope of protection of the present disclosure.

It should be noted that any directional indications (such as up, down, left, right, front, rear, etc.) used in the embodiments of the present disclosure are solely for explaining the relative positions and movements of components in a specific orientation. Should this specific orientation change, the directional indications will correspondingly change as well.

Additionally, where descriptions such as “first,” “second,” etc., appear in the embodiments of the present disclosure, such designations are used solely for descriptive purposes and should not be construed as indicating or implying relative importance or as implicitly specifying the number of technical features indicated. Consequently, features defined as “first,” “second,” etc., may explicitly or implicitly include at least one such feature. Moreover, the terms “and/or” or “as well as/or” appearing throughout the text encompass three parallel alternatives. For example, “A and/or B” includes alternative A, alternative B, or both A and B simultaneously. Where the present disclosure states that “element A” includes “element B,” unless explicitly excluded or contextually precluded, such inclusion signifies that element A contains one or more instances of element B. Furthermore, technical solutions among different embodiments may be combined with each other, provided such combinations are feasible for a person skilled in the art. Where a combination of technical solutions results in mutual contradictions or is unfeasible, such a combination shall be deemed non-existent and shall not fall within the scope of protection claimed by the present disclosure.

In this specification, when two values are described as “roughly the same,” it means the difference between the two values divided by the larger value is less than or equal to 0.05. When two values are described as ‘identical’ or “the same,” it means the difference between the two values divided by the larger value is less than or equal to 0.01. It should be noted that all diagrams of the present disclosure are drawn to scale, and the dimensional proportions and relative positions of the components should be considered part of the disclosure.

The present disclosure proposes a high-power connector used to supply power to a server. Through the following design, terminals can be securely fixed within each connector assembly without significantly increasing dimensions, ensuring proper device operation.

The following describes the design of the high-power connector of the present disclosure through an exemplary embodiment. The connector assembly includes two mating connectors. Typically, the male connector terminates at the cable end, while the high-power connector is fixed within the cabinet. During operation, the user inserts the male connector at the cable end into the high-power connector at the server location to establish electrical connection between the two.

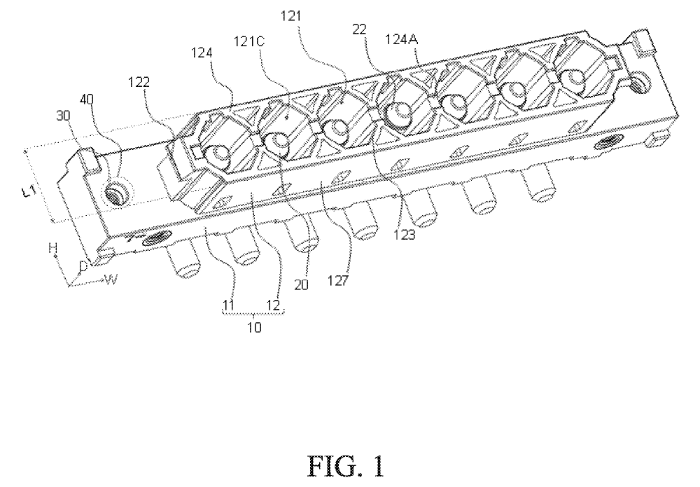

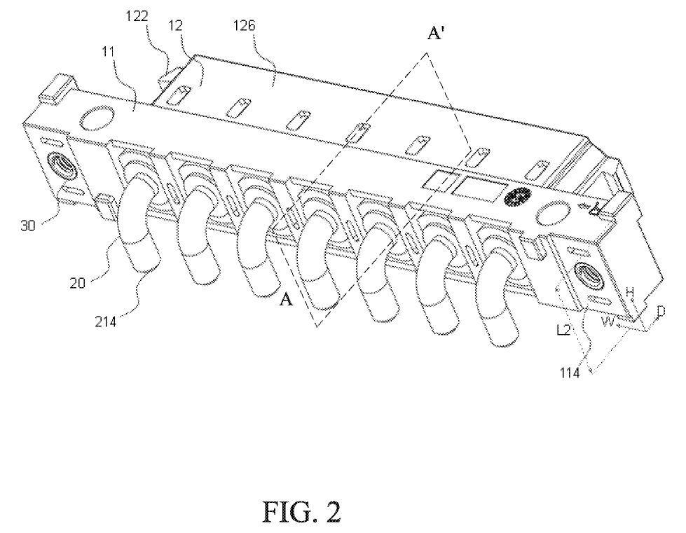

The following describes the design of high-power connectors. Refer to FIG. 1, FIG. 2 and FIG. 6. FIG. 1 is a schematic diagram of the overall structure of a high-power connector according to at least one embodiment of the present disclosure. FIG. 2 is a schematic diagram of the high-power connector in FIG. 1 from another perspective. FIG. 6 is schematic a cross-section drawn of the high-power connector along section A-A’ in FIG. 2. In the embodiment, the high-power connector A primarily includes a base 10, a plurality of terminal modules, two internally threaded metal tubes 30, and a fastener 40.

The following describes the design of base 10. Refer to FIG. 1. The base 10 is formed integrally from insulating material. More precisely, the base 10 is formed integrally from insulating material via an injection molding process. Base 10 can be broadly divided into a socket portion 12 for mating with a male connector and a main body portion 11 connected thereto. The opposite sides of the socket portion 12 have reverse hooks 122 respectively. The reverse hooks 122 are disposed on the opposite sides of the socket portion 12. The socket portion 12 includes at least five front channels 121 and reverse hooks 122.

Refer to FIG. 1. The socket portion12 is connected to the front of the main body portion 11. The maximum height of the socket portion 12 along a height direction H is called the maximum height of the socket portion, which is approximately 13mm. The maximum height of the socket portion is defined as the first height L1. In some embodiments, the first height L1 is between 11 mm and 25 mm. The socket portion 12 includes at least five front channels 121 arranged side by side. The socket portion 12 includes at least five front channels 121, each front channel having a front end opening 121C for accommodating a terminal module 20 respectively. At least five front channels 121 is arranged side by side, each of the front channels 121 communicating with a corresponding one of the rear channels 111 and extending from a rear toward a front thereof.

Each of the front channels 121 includes a positioning channel wall 121A located on an upper side of the front channel 121, the positioning channel wall 121A having a positioning groove 121B extending in a front-to-back direction.

The front end opening 121C of each of the front channels 121 has a polygon shape. A periphery of the polygonal shape is collectively defined by a plurality of substantially straight edges. Refer to FIG. 1. In the embodiment, the inner surface of the front channel 121 includes eight front channel walls 123 being adjacent to each other, each of which is substantially planar, such that the inner contour of the front channel 121 is substantially octagonal and columnar. The inner contour at the end face of the front end opening 121C of each front channel 121 is also substantially octagonal. A front end surface 124 of the front channel wall 123 between two front channels 121 being adjacent is provided with a transverse groove 124A. The transverse groove 124A is recessed along a length direction D and extends along a width direction W to interconnect the two front channels 121 being adjacent. In other words, the socket portion 12 further includes the transverse groove 124A. The transverse groove 124A is defined in a front end surface 124 of the socket portion 12 between two adjacent front channels 121. The transverse groove 124A extends in a width direction to communicate the two adjacent front channels 121. The maximum depth of each transverse groove 124A along the length direction D is referred as the transverse groove depth, which is approximately 0.6 mm. When this transverse groove depth falls between 0.3 and 1 mm, the design optimally combines strength requirements with alignment needs.

Refer to FIG. 1 and FIG. 6. See FIGS. 1 and 6. The base 10 of high-power connector A has a plurality of channels, which can be divided into the front channel 121 located at the front and the rear channel 111 located at the rear. The rear channel 111 is located within the main body portion 11. In other words, the main body portion 11 includes the rear channel 111 and a through hole extending in a front-to-back direction through the main body portion 11. Each front channel 121 communicates with the rear channel 111 corresponding thereto and extending from the rear toward the front. Each terminal modules 20 is respectively disposed in one of the front channels 121 and the corresponding one of the rear channels 111.

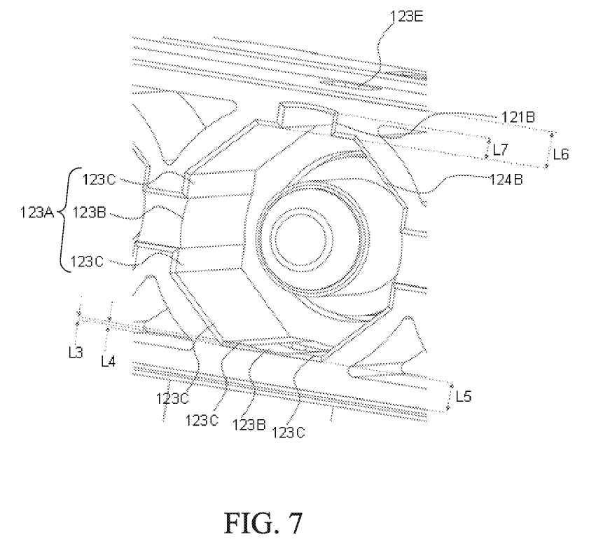

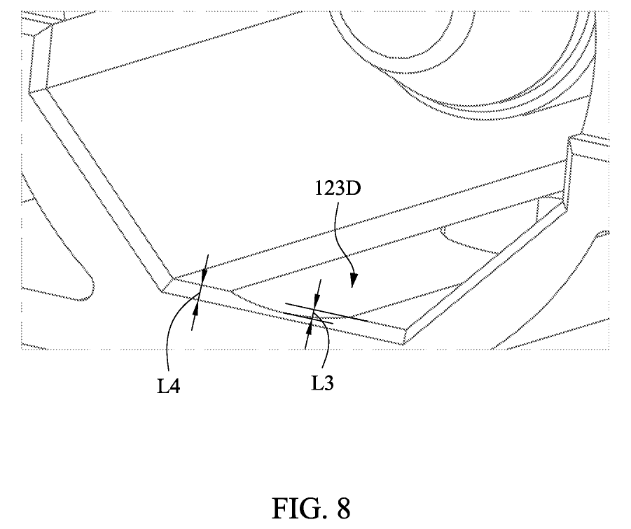

Specifically, as shown in FIG. 6 to FIG. 8. FIG. 8 is an enlarged schematic diagram of the front-lower view perspective shown in FIG. 7. A guide slope 124B having a certain thickness is provided at the edge of the front end opening 121C of the front channel 121. The left, right, and lower sides of the front channel 121 are provided with three relief channel walls 123A. Each relief channel wall 123A includes planar walls 123C and a relief groove 123B located at the center of the relief channel wall 123A, in which the relief channel walls 123A positioned on the left and right sides face each other. In other words, the relief groove 123B is placed between two planar walls 123C(also referred to as two first planar walls). Each relief groove 123B is a shallow curved groove with an arcuate bottom surface 123D. The bottom of each of the relief groove 123B is a curved surface.

This design provides additional space for mating male connectors, thereby reducing interference caused by dimensional tolerances. Taking the relief groove 123B located at the lower position as an example, the deepest point along the height direction H is referred to as a relief depth L3. Specifically, the relief depth L3 is a maximum recession distance in the height direction H from a planar surface of the relief channel wall 123A to an arcuate bottom surface 123D. The thickness of the guide slope 124B extending inward along the height direction H is termed the guide slope thickness L4. That is, the guide slope thickness L4 can be defined as the distance between the top edge and the bottom edge of the guide slope 124B. In this example, the relief depth L3 is 0.2 mm. The recommended range for relief depth L3 is between 0.05 mm and 0.5 mm. The remaining four inclined front channel walls 123 are essentially planar walls 123C (also referred to as second planar walls). Specifically, each planar wall 123C is respectively disposed between a lateral relief channel wall 123A and either the bottom relief channel wall 123A or the top positioning channel wall 121A to collectively define the polygonal shape.

In an embodiment, the front end surfaces 124 of the at least five front channels 121 arranged side by side are provided with guide slopes 124B respectively. The guide slope 124B extends inward from the front end opening 121C, in which the projected thickness of the guide slope 124B along the height direction H is defined as the guide slope thickness L4. In the embodiment, the guide slope thickness L4 is approximately 0.3 mm. An edge of the front end surface 124 of the socket portion 12 at an opening of each of the at least five front channels is provided with a guide slope 124B. Each front channel 121 is surrounded by a front channel wall 123. The front channel walls 123 refer to the eight adjacent surfaces on the inner side of the front channel 121, wherein each surface is substantially planar. Specifically, while some of the front channel walls 123 incorporate a relief groove 123B, the depth of the relief groove 123B is sufficiently shallow such that the overall structure of the front channel wall (123) remains substantially planar. In an embodiment, the maximum thickness of front channel wall 123 of the upper side of each front channel 121 is referred to as the maximum thickness of the upper side channel wall, which is approximately 2mm. The maximum thickness of the upper side channel wall is the second thickness L6.

Each of the front channel walls 123 includes a positioning channel wall 121A respectively. The positioning channel wall 121A is located on the top side (upper side) of the front channel 121 and is equipped with a positioning groove 121B for anti-misinsertion purposes. In other words, each of the front channels 121 includes a positioning channel wall 121A located on the upper side respectively. In the embodiment, the maximum height of the positioning groove 121B along the height direction H is called the maximum height of the positioning groove, which is about 1 mm. The maximum height of the positioning groove is the third height L7. The third height L7 accounts for about 50% of the thickness of the front channel wall 123 located on the upper side. To maintain structure strength, the third height L7 should be controlled between 0.5 mm and 1.5 mm. Alternatively, the third height L7 should ideally fall between 30% and 70% of the second thickness L6 to achieve both of foolproof function and structural rigidity. That is to say, the two relief channel walls 123A located on opposite sides are connected by at least two front channel walls 123 comprising planar walls 123C (i.e., second planar wall) and positioning channel wall 121A.

Additionally, an interior of at least one of the at least five front channels 121 arranged side by side includes a plurality of the front channel walls 123 that are adjacent to one another. Each front channel walls 123 further includes a plurality of relief channel walls 123A respectively. In other words, the front channel walls 123 include at least two relief channel walls 123A. The relief channel walls 123A are positioned on the left side, right side and lower side of the front channel 121, and a relief groove 123B is provided at the center of each of the relief channel walls 123A. The relief channel walls 123A of the left-facing and right-facing are arranged opposite each other. In other words, the relief channel wall 123A includes two lateral relief channel walls and a bottom relief channel wall. The bottom relief channel wall has a relief groove 123B extending along the front-to-back direction.

The relief groove 123B is a shallow curved groove featuring an arcuate bottom surface 123D to provide additional clearance space for mating male connectors. In other words, the bottom of the relief groove 123B in each of the two relief channel walls 123A is provided with an arcuate bottom surface 123D. The maximum recess depth of this relief groove 123B along the height direction H (or radial direction) is defined as the relief depth L3. In the embodiment, the relief depth L3 is approximately 0.2 mm with a recommended range between 0.05 mm and 0.5 mm. The relief depth L3 can be less than or equal to the guide slope thickness L4. The thickness of the guide slope 124B is between 0.05 mm and 0.5 mm. In other words, the guide slope thickness L4 is between 0.05 mm and 0.5 mm.

The relief channel wall 123A which is provided with the relief groove 123B, has a maximum thickness defined as a maximum thickness of the relief channel wall. The maximum thickness of the relief channel wall is a first thickness L5. The relief depth L3 should ideally be less than or equal to 15% of the first thickness L5 to provide clearance space for tolerances without compromising structural strength. That is to say, the relief depth L3 can be less than or equal to the guide slope thickness L4. Alternatively, the relief depth L3 can be less than or equal to 15% of the first thickness L5 of the front channel wall 123 where it is located. In other words, the depth of the relief groove 123B along the height direction H occupies no more than 15% of the maximum thickness of the front channel wall 123 located. In the embodiment, the first thickness L5 is approximately 1.7 mm.

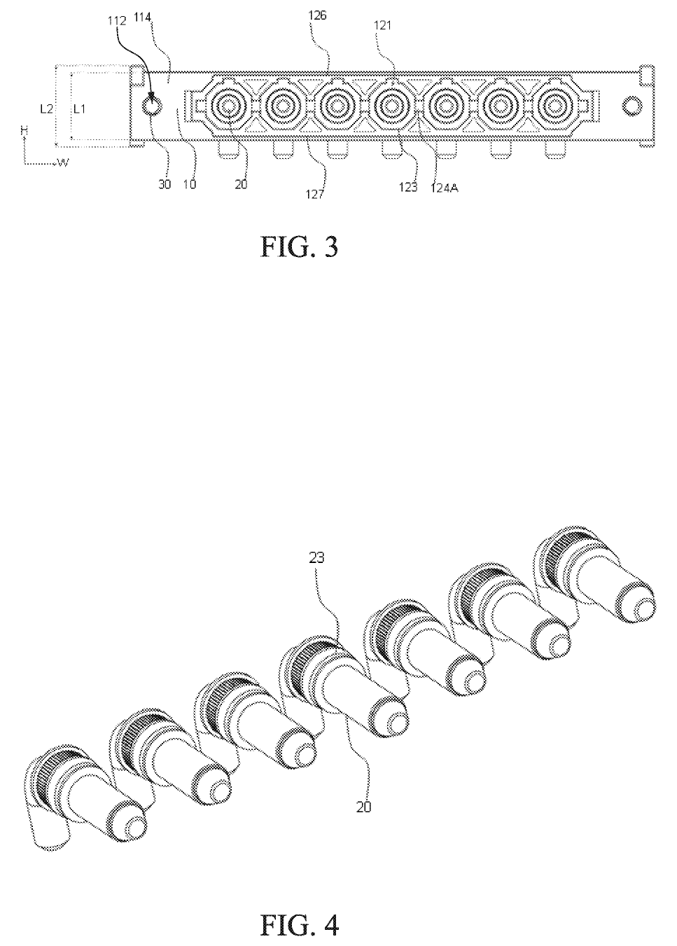

Additionally, each of the front channel walls 123 individually includes a plurality of planar walls 123C. These planar walls 123C include the remaining four inclined wall surfaces, and the inner surfaces of these planar walls 123C are essentially planar (not curved). Additionally, as shown in FIG. 7 and 6, and in conjunction with FIG. 3, the two relief channel walls 123A are connected via at least two front channel walls 123 including planar walls 123C and positioning channel wall 121A. The positioning channel wall 121A is interconnected between the two lateral relief channel walls via two of the planar walls 123C respectively located at an upper portion of the interior. In other words, the two relief channel walls 123A are connected via at least two planar walls123C and the positioning channel wall 121A.

Each rear channel 111 is formed by a rear channel wall 111A. The rear channel wall 111A refers to the wall surface of rear channel 111. The rear channel wall 111A and the front channel wall 123 comprise a stepped wall structure with different inner diameters.

As shown in FIG. 6, the positioning groove 121B extends along the length direction D all the way to the bottom wall 121D at the base of the front channel 121. The bottom wall 121D serves to support the male connector and limit its insertion depth. Each front channel 121 communicates with the exterior through vent holes 123E provided on the upper and lower sides of the front channel wall 123, where the width of the vent holes 123E is equal to the maximum width of the relief groove 123B in the width direction W.

Additionally, as shown in FIG. 6 and FIG. 7, both the upper and lower sides of the front channel wall 123 of each front channel 121 are connected to horizontal support walls 125, which are used to reinforce the structural strength of each front channel 121. Simultaneously, gaps are formed between the upper portion and lower portion of the front channel wall 123 of each front channel 121 and each horizontal support wall 125, respectively forming an upper coplanar surface 126 and a lower coplanar surface 127 on the upper and lower sides, respectively. In other word, refer to FIG. 2 and FIG. 3. The socket portion 12 includes a plurality of horizontal support walls, an upper coplanar surface and a lower coplanar surface. The horizontal support walls is interconnected the front channel walls. The upper coplanar surface 126 facing upward. The lower coplanar surface 127 facing downward. The upper coplanar surface 126 is jointly formed by top surfaces of the front channel walls 123 along the height direction H and top surfaces of the horizontal support walls that are flush with each other along the width direction W. The lower coplanar surface 127 is jointly formed by bottom surfaces of the front channel walls 123 along the height direction H and bottom surface of the horizontal support walls that are flush with each other along the width direction W.

Refer to FIG. 3. FIG. 3 is a front-view schematic diagram of the high-power connector shown in FIG. 1. The maximum height of the main body portion 11 along the height direction H is called the maximum height of the main body portion, which is about 17 mm, about 30% higher than the first height L1. The maximum height of the main body portion is the second height L2. In an embodiment, the second height L2 may range from 12 mm to 26 mm and be slightly greater than the first height L1. In other words, the first height L1 is less than the second height L2. It can also be said that the maximum height of socket portion 12 along the height direction H is less than the second height L2.

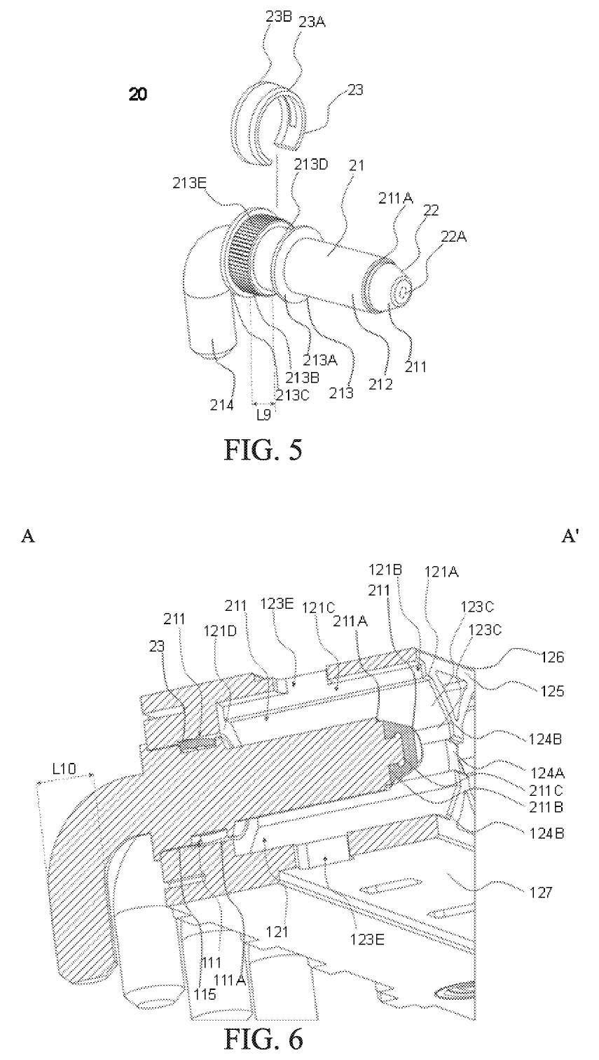

Refer to FIG. 4 and FIG. 5. FIG. 4 is a schematic diagram of the terminal modules for the high-power connector shown in FIG. 1. FIG. 5 is a schematic diagram of the component structure of the terminal module shown in FIG. 4. The following describes the design of terminal module 20, in which each terminal module 20 generally includes a metal terminal 21, a C-shaped retaining ring 23 mounted on the surface of the metal terminal 21, and an insulating cap 22 fixedly mounted on the top of the metal terminal 21. The C-shaped retaining ring 23 is engaged with a surface of the metal terminal 21.

Refer to FIG. 5 and FIG. 6. The main body portion 11 (as shown in FIG. 2) is equipped with a plurality of rear channels 111. Each rear channel 111 communicates with a front channel 121 corresponding thereto. The rear channel 111 features a stepped structure that widens toward the front and narrows toward the rear. The stepped structure has a step platform 115 in the middle. The step platform 115 is used to support the C-shaped retaining ring 23 on the metal terminal 21 in an outwardly expanding state, and to prevent the metal terminal 21 from retracting from the base 10 (shown on FIG. 3 and FIG. 1) and the front channel 121 thereof. In other words, the C-shaped retaining ring 23 is configured to abut against the base 10 to prevent the metal terminal 21 corresponding thereto from retreating backward from the base 10. The main body portion 11 provides a surface at the edge of the opening relative to the rear channel 111 for a rear protruding ring 213C of the metal terminal 21 to abut against, thereby limiting the depth of terminal insertion into the base 10.

Refer to FIG. 3. Both sides of the main body portion 11 are provided with a through hole 112 extending in the front-to-back direction respectively. Each through hole 112 is provided for embedding a internally threaded metal tube 30 with a rough outer surface, thereby forming an internal thread within the through hole 112. In other words, two internally threaded metal tubes 30 are respectively embedded in the through holes 112 defined at two lateral sides of the main body portion 11, in which the two internally threaded metal tubes 30 to provide an internal thread within the through hole 112. The internally threaded metal tube 30 is secured to the cabinet panel by a fastener 40 (e.g., a screw) as shown in FIG. 1.

The metal terminal 21 is an overall solid copper terminal with a roughly cylindrical shape. The metal terminal 21 includes a head 211, a body 212, a waist 213, and a foot portion 214 connected in sequence from front to back. The foot portion 214 is cylindrical in shape and has a diameter between 2 mm and 10 mm.

The head 211 includes an annular beveled shoulder 211A, which guides the mating terminals within it when engaging with a male connector. The insulating cap 22 (as shown in FIG. 5) is mounted on the protrusion 211C (as shown in FIG. 6) of the top surface 211B (as shown in FIG. 6) of the head 211 of metal terminal 21 (as shown in FIG. 5 and FIG. 6). In the embodiment, the insulating cap 22 is integrally formed and attached to the protrusion 211C through an injection molding process. If necessary, the two components may also be secured by means such as snap-fitting or bonding. A partition wall, oriented substantially perpendicular, is provided between the top surface 211B and the annular beveled shoulder 211A (as shown in FIG. 6) to isolate the two. The insulating cap 22 features a truncated conical structure with a maximum diameter of approximately 4.5 mm. In an embodiment, the diameter of the insulating cap 22 can be adjusted as needed between 3 mm and 10 mm, while the dimensions of its front end surface 124 (as shown in FIG. 1) should be correspondingly adjusted. The maximum height of the insulating cap 22 is approximately 2mm. In an embodiment, it can be adjusted to between 1mm and 3mm as required. In the embodiment, the maximum height-to-width ratio of the insulating cap 22 is 0.44. In an embodiment, it can be further adjusted as required to fall between 0.4 and 0.5. However, when the height-to-width ratio of the insulating cap 22 is maintained at 0.45 or below 0.3, its surface area and volume are reduced. During high-temperature carbonization, fewer carbon particles are released, further mitigating the overall efficiency loss caused by carbon contamination on the terminal surface. It should be noted that the top surface of the insulating cap 22 is not limited to a flat surface. In an embodiment, refer to FIG. 5, one opening 22A (indicated by dashed lines) must be formed (as shown in FIG. 5) to expose the front end surface 124 of the component (as shown in FIG. 1). In other words, the insulating cap 22 of each of the terminal modules 20 has at least one opening 22A defined therein to expose a part of a top surface of the metal terminal 21.

Refer to FIG. 5. The body 212 of the metal terminal 21 is uniformly cylindrical in shape. In the embodiment, the maximum cylindrical diameter of body 212 is approximately 5 mm. In an embodiment, it can be adjusted as required to between 4 mm and 10 mm.

See FIG. 5, the waist 213 is roughly cylindrical in shape. Terminal module 20 further includes a front protruding ring 213A, a middle protruding ring 213B, and the rear protruding ring 213C connected sequentially from front to rear. Terminal module 20 features a storage slot 213D positioned between the front protruding ring 213A and the middle protruding ring 213B. The maximum length of the storage slot 213D in the front-to-back direction is referred to as the storage slot length L9. The storage slot length L9 is equal to the maximum length of the C-shaped retaining ring 23 along the length direction D (front-back direction), so as to allow the C-shaped retaining ring 23 to be embedded therein. The C-shaped retaining ring 23 features that is thinner at the front and thicker at the rear meaning the rear end 23B of the C-shaped retaining ring 23 is thicker than the front end 23A of the C-shaped retaining ring 23.

In the embodiment, to prevent the metal terminal 21 from rotating axially, a rough surface 213E may be formed on the surface of the middle protruding ring 213B to increase the frictional force when contacting the rear channel wall 111A of the rear channel 111 of the main body portion 11 of the base 10. In the embodiment, the rough surface 213E comprises a plurality of triangular protrusions extending uniformly from front to rear, which engage to some degree with the rear channel wall 111A of the rear channel 111 of the main body portion 11. When the end of the metal terminal 21 (as shown in FIG. 5) is wired and the foot portion 214 (as shown in FIG. 5) does not require bending, the rough surface 213E design may be optionally omitted. The rear protruding ring 213C has a larger diameter than the front protruding ring 213A. The rear protruding ring 213C is used to abut against the rear wall 114 of the main body portion 11 (as shown in FIG. 3), thereby limiting the depth to which the metal terminal 21 can enter the base 10.

Refer to FIG. 6. The foot portion 214 (as shown in FIG. 5) includes a bent columnar body with a uniform circular cross-section. The maximum diameter of this columnar body is referred to as the foot diameter L10, which is approximately 4 mm. In an embodiment, the foot diameter L10 shall not be less than 2 mm and may be increased as needed to 5 mm to 10 mm, with a maximum width equal to that of the body 212 (as shown in FIG. 5). Notably, common high-power connectors can be categorized into three types: fully soldered board-type, fully soldered wire-type, or hybrid-type. FIG. 1 illustrates a fully soldered board type, where each terminal connects downward to the conductive vias of the circuit board. Alternatively, it may be a wire-bonded type, where the foot portion 214 of the metal terminal 21 (as shown in FIG. 5) is straightened without bending and then soldered to the wire at its tail end. A hybrid type refers to a configuration where only one terminal (such as the central ground terminal) is wire-bonded, while the others are soldered to the circuit board, as exemplified here.

The foregoing description is merely an exemplary embodiment of the present disclosure and shall not be construed as limiting the scope of the disclosure. Any equivalent structural modifications made under the technical concept of the present disclosure and based on the content of the specification and drawings, or any direct/indirect application in other related technical fields, are all included within the scope of the patent protection of the present disclosure.

What is claimed is:

1. A high-power connector for supplying power to a server, comprising:
a base integrally formed from insulating material, and the base comprising:
a main body portion including a rear channel and a through hole extending in a front-to-back direction through the main body portion, wherein a maximum height of the main body portion in a height direction is between 12 mm and 26 mm; and
a socket portion connected to a front of the main body portion, and the socket portion comprising:
at least five front channels arranged side by side, each of the front channels communicating with a corresponding one of the rear channels and extending from a rear toward a front thereof; and
reverse hooks disposed on opposite sides of the socket portion; and
wherein each of the front channels includes a positioning channel wall located on an upper side of the front channel, the positioning channel wall having a positioning groove extending in the front-to-back direction, wherein a maximum height of the socket portion in the height direction is between 11 mm and 25 mm, wherein the maximum height of the socket portion is less than the maximum height of the main body portion, and a maximum depth of the positioning groove in the height direction is between 0.5 mm and 1.5 mm; and
a plurality of terminal modules respectively disposed in the front channels and the rear channels, and each of the terminal modules comprising:
a metal terminal including a foot portion; and
an insulating cap fixedly mounted on a top of the metal terminal, wherein the foot portion is cylindrical in shape and has a diameter between 2 mm and 10 mm.

2. The high-power connector of claim 1, wherein the socket portion further comprises:
a transverse groove defined in a front end surface of the socket portion between two adjacent front channels; and
wherein the transverse groove extends in a width direction to communicate the two adjacent front channels.

3. The high-power connector of claim 1, wherein each terminal module further comprises:
a C-shaped retaining ring engaged with a surface of the metal terminal; and
wherein the C-shaped retaining ring is configured to abut against the base to prevent the metal terminal corresponding thereto from retreating backward from the base.

4. The high-power connector of claim 1, further comprising:
Two internally threaded metal tubes respectively embedded in the through holes defined at two lateral sides of the main body portion, wherein the two internally threaded metal tubes to provide internal thread within the through hole respectively.

5. The high-power connector of claim 2, wherein an edge of the front end surface of the socket portion at an opening of each of the at least five front channels is provided with a guide slope, and a guide slope thickness is between 0.05 mm and 0.5 mm.

6. The high-power connector of claim 2, wherein the insulating cap of each of the terminal modules has at least one opening defined therein to expose a part of a top surface of the metal terminal.

7. The high-power connector of claim 3, wherein a rear end of the C-shaped retaining ring is thicker than a front end of the C-shaped retaining ring.

8. The high-power connector of claim 4, wherein an interior of at least one of the at least five front channels comprises:
a plurality of front channel walls including a plurality of relief channel walls;
wherein the relief channel wall comprises:
two lateral relief channel walls facing each other; and
a bottom relief channel wall having a relief groove extending along the front-to-back direction.

9. The high-power connector of claim 8, wherein the front channel walls further comprises:
a plurality of planar walls; and
a positioning channel wall interconnected between the two lateral relief channel walls via two of the planar walls respectively located at an upper portion of the interior; and
wherein a relief depth of the relief groove along the height direction is between 0.05 mm and 0.5 mm, and the relief depth is no more than 15% of a maximum thickness of the relief channel wall.

10. The high-power connector of claim 9, wherein a bottom of each of the relief grooves is a curved surface.

11. The high-power connector of claim 8, wherein the socket portion further comprises:
a plurality of horizontal support walls interconnected the front channel walls;
an upper coplanar surface facing upward; and
a lower coplanar surface facing downward;
wherein the upper coplanar surface is jointly formed by top surfaces of the front channel walls and top surfaces of the horizontal support walls that are flush with each other along a width direction; and
wherein the lower coplanar surface is jointly formed by bottom surfaces of the front channel walls and bottom surfaces of the horizontal support walls that are flush with each other along the width direction.

12. The high-power connector of claim 8, wherein a front end opening of each of the front channels has a polygon shape; and
wherein a periphery of the polygonal shape is collectively defined by a plurality of substantially straight edges.

13. A high-power connector for supplying power to a server, comprising:
a base integrally formed from insulating material, and the base comprising:
a main body portion including a rear channel and a through hole extending in a front-to-back direction through the main body portion; and
a socket portion connected to a front of the main body portion, and the socket portion comprising:
at least five front channels arranged side by side, each of the front channels communicating with a corresponding one of the rear channels and extending from a rear toward a front thereof;
reverse hooks respectively disposed on opposite sides of the socket portion; and
a transverse groove defined in a front end surface of the socket portion between two adjacent front channels, wherein the transverse groove extends in a width direction to communicate the two adjacent front channels;
wherein each of the front channels includes a positioning channel wall located on an upper side of the front channel, and the positioning channel wall having a positioning groove extending in the front-to-back direction, wherein a maximum height of the socket portion in the height direction is less than the maximum height of the main body portion; and
wherein a front end opening of each of the front channels has a polygonal shape, and a periphery of the polygonal shape is collectively defined by a plurality of substantially straight edges;
a plurality of terminal modules respectively disposed in the front channels and the rear channels, each of the terminal modules comprising:
a metal terminal including a foot portion; and
an insulating cap fixedly mounted on a top of the metal terminal, wherein the foot portion is cylindrical in shape.

14. The high-power connector of claim 13, wherein each terminal module further comprises:
a C-shaped retaining ring engaged with a surface of the metal terminal; and
wherein the C-shaped retaining ring is configured to abut against the base to prevent the metal terminal corresponding thereto from retreating backward from the base.

15. The high-power connector of claim 13, further comprising:
Two internally threaded metal tubes respectively embedded in the through holes defined at two lateral sides of the main body portion, wherein the two internally threaded metal tubes to provide internal thread within the through hole respectively.

16. The high-power connector of claim 14, wherein the rear channel features a stepped structure that widens toward the front and narrows toward the rear;
wherein the stepped structure has a step platform in the middle; and
wherein the step platform is used to support the C-shaped retaining ring on the metal terminal in an outwardly expanding state, and to prevent the metal terminal from retracting from the base and the front channel thereof.

17. The high-power connector of claim 13, wherein the maximum height of the socket portion is between 11mm and 25mm.

18. The high-power connector of claim 13, wherein a maximum depth of the transverse groove along a length direction is referred as a transverse groove depth; and
wherein the transverse groove depth is between 0.3 mm and 1 mm.

19. The high-power connector of claim 13, wherein the maximum height of the main body portion ranges from 12 mm to 26 mm and is greater than the maximum height of the socket portion.

20. The high-power connector of claim 13, wherein a diameter of the insulating cap is between 3 mm and 10 mm.
